(19) United States
(12) Patent Application Publication
(10) Pub. No.: US 2007/0157822 A1
(43) Pub. Date: Jul. 12, 2007

(54) Cartridge for preparation of a beverage

(75) Inventor: Cosimo Fusco, Trieste (IT)

Correspondence Address: LUCAS & MERCANTI, LLP, 475 PARK AVENUE SOUTH, 15TH FLOOR, NEW YORK, NY, 10016, US

(73) Assignee: ILLYCAFFE S.P.A., TRIESTE (IT)

(21) Appl. No.: 10/596,084

(22) PCT Filed: Dec. 9, 2004
(86) PCT No.: PCT/IT04/00681

§ 371 Date: Jun. 1, 2006

(30) Foreign Application Priority Data
Dec. 11, 2003 (IT) MI2003 A 00242

(51) Int. Cl. A47J 31/00

(52) U.S. Cl. 99/295

(57) ABSTRACT

A cartridge for the preparation of a beverage consists of a lateral cylindrical surface (S) obtained by rolling of a sheet and welding thereof along a line (L), as well as a top base (T) and a bottom base (B) welded to the cylindrical surface (S) so as to close the apertures at the ends of the latter, both the cylindrical surface (S) and the bases (B, T) being made from a flexible and gastight material. In this way a cartridge is obtained with a regular shape and easy to manufacture that not only is cheaper, more efficient and more environmentally friendly than prior art cartridges, but it also allows to make a coffee machine that is cheaper, more practical and lighter and can even be totally automatic.

The present invention relates to cartridges for the preparation of beverages, and in particular to a cartridge having an elongated cylindrical shape. Specific reference will be made hereafter to a coffee cartridge, while it is clear that what is being said is also applicable to the preparation of other similar beverages obtained from granulated or powdered substances (barley, chocolate, tea, infusions, etc.).

Cartridges for the preparation of beverages are known since many years, and they are used in machines in which the extraction of the beverage is performed by passing hot water through the cartridge. Prior art cartridges can be divided essentially into three types: a round flat cartridge (waffle) obtained by sealing the substance between two bands of flexible material, a short and wide cylindrical cartridge provided with openings on the bases and made of rigid plastic material, and a frustoconical aluminum cartridge sealed by a membrane applied on the aperture formed at the larger base.

An example of the first type of cartridge is found in U.S. Pat. No. 3,607,297, that shows how this is the oldest and most unpractical type of cartridge. In fact it has various drawbacks: the machines that manufacture these cartridges are very slow, the appearance of the cartridge before and especially after use is not attractive, it is not possible to pressurize the content of the cartridge with inert gas to prevent the loss of aroma, and finally the automatic feeding of the cartridges in the machines that uses them can take place only be leaving them joined in a band which is quite cumbersome and unpractical.

The second type of cartridge is illustrated, for example, in U.S. Pat. No. 4,471,689, WO 93/17932 and EP 1.042.978 and also has some drawbacks. In the first place it is an expensive cartridge with a high environmental impact, since it is made with a structure of rigid plastic material that in turn is enclosed by an airtight package. Furthermore, also in this case it is not possible to pressurize the content of the cartridge to prevent the loss of aroma, and it is not possible to obtain a simple automatic feeding since each cartridge must be removed from its package prior to use.

The third type of cartridge is disclosed for the first time in CH 605.293, and various subsequent improvements and/or modifications are illustrated in EP 0.468.078, WO 92/07775 and EP 0.512.468. In this cartridge the body is obtained by drawing of an aluminum sheet and also the closure membrane is made of aluminum, possibly coupled with other materials. In this case, too, the cost and the environmental impact of the cartridges are high, since they use up to 1.3 g of aluminum to contain 5 g of coffee. Pressurization of the cartridge content is possible, but the pressure that can be achieved is quite low (around 0.2 bar, i.e. 20.000 Pa). This results from the fact that the area of the aperture is quite large and the closure membrane of small thickness (30-60 μm) can not withstand a higher pressure without a significant increase in thickness and therefore in cost. Moreover, the membrane is intended to be torn by the pressure generated inside the cartridge, whereby it can not be too resistant otherwise it would not allow the outflow of the beverage.

Furthermore, there is to consider that the frustoconical shape, in particular in the version with double taper, makes the automatic feeding yet more complicated by the less regular shape, and implies more room taken up by the cartridges in the retail package.

Finally, a drawback common to all three types of prior art cartridges is that it is not easy to change the amount of substance contained in each cartridge, and this results particularly disadvantageous in the case of coffee. In fact, although a small range of change in content can be achieved by acting on the coffee density (by compression and/or through the presence of an inert gas) without changing the cartridge size, nonetheless it is not possible to achieve a coffee range from the short strong espresso to the long light coffee.

Therefore the object of the present invention is to provide a cartridge which overcomes the above-mentioned drawbacks. This object is achieved by means of a cartridge having an elongated cylindrical shape, consisting of a cylindrical surface, obtained by welding along a generatrix a sheet of gastight material, that is closed at the ends by bases of similar material welded to the cylindrical surface.

Such a cartridge has several important advantages both in manufacturing and in use, which can be summarized as follows:
a) the production is very fast since both the body and the bases are obtained from bands through simple operations: cutting, rolling and welding for the body and cutting and drawing for the bases that are subsequently welded to the body;
b) for the same amount of coffee there is required much less aluminum with respect to the third type of cartridge: when using multi-layer sheet material similar to the material used for the packaging of the second type of cartridge, the aluminum content is reduced by about 65%;
c) the regular shape allows to reduce to the minimum the size of the packaging, thus reducing the costs for packaging, transport and storage;
d) the regular shape allows to easily implement the automatic feeding of the cartridge: the package itself can even act as a hopper for the machine and the procedure to prepare a coffee can become a simple matter of pushing a button for the user;
e) the elongated cylindrical shape allows to change the coffee content within a very wide range simply by changing the body height without changing the cross-section thereof: it is therefore possible to obtain any kind of coffee from the short one to the long one (e.g. from 12 to 150 cc of coffee) depending on the cartridge dosage (e.g. from 2 to 20 g);
f) from the combination of the two previous points there is obtained the possibility of making a machine that automatically detects the cartridge length and consequently adjusts the water amount to be used for the extraction of the coffee;
g) the elongated cylindrical shape allows to significantly reduce the coffee content in low-dosage cartridges while retaining a thickness of the coffee layer sufficient to assure an optimal extraction; for example, when using a 5 g cartridge that contains only 3.7 g of coffee (the rest being inert gas) with the same amount of water, one can obtain a coffee of the same volume yet with a lower content in caffeine, so that the user can take his daily dose of caffeine divided over a greater number of coffees;
h) the small area of the aperture for the coffee outflow allows to obtain a higher pressurization of the cartridge (0.5-1 bar, i.e. 50.000-100.000 Pa) while maintaining the base thin enough to allow the tearing thereof under the effect of the internal pressure;
i) the small area of the cross-section implies a lower push on the cartridge-holder during the extraction with pressurized water: the machine can therefore be made with a lightweight and cheap structure, is more reliable, and the user has no difficulty in tightening the cartridge-holder (which with prior art cartridges may even involve an excessive effort for a weak person).

This list of advantages shows that not only the present cartridge is cheaper, more efficient and more environmentally friendly than prior art cartridges, but it also allows to make a coffee machine that is cheaper, more practical and lighter and can even be totally automatic.

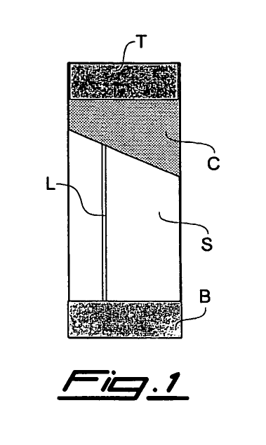

Further advantages and characteristics of the cartridge according to the present invention will be clear to those skilled in the art from the following detailed description of an embodiment thereof, with reference to the only drawing, annexed as FIG. 1, wherein the cartridge is diagrammatically illustrated in a partially sectional side view.

With reference to said figure, there is seen that the cartridge consists of a lateral cylindrical surface S obtained by rolling of a sheet and welding thereof along a line L. The apertures at the ends of the cylindrical surface S are closed by a top base T welded inside the cylindrical surface and by a bottom base B welded outside the cylindrical surface.

The sheet used for cylindrical surface S is preferably a multi-layer material consisting of PET+aluminum+PET+polythene on the outer surface to facilitate the printing of the brand of coffee C enclosed therein; the bases B, T are obtained by drawing from a similar material, preferably PET+aluminum.

It is clear that any other sheet material having similar characteristics of flexibility and gas tightness may be used instead of the above-mentioned materials.

The welding of cylindrical surface S along line L and the welding of bases B, T on cylindrical surface S are preferably carried out through heat sealing, but obviously other joining processes are also possible such as ultrasonic sealing, gluing and the like.

The diameter of the cartridge is indicatively between 15 and 30 mm, preferably about 24 mm, and its height is proportional to the dose of coffee C that it is intended to contain, as previously explained. The height/diameter ratio of the cartridge may obviously change according to the dosage as long as the elongated cylindrical shape is retained, i.e. the ratio is indicatively greater than 1.5:1.

It should be noted that the above-mentioned dimensions relate to a monodose coffee cartridge, but they could be freely changed according to the needs, namely according to the substance from which the beverage is extracted and/or to the number of doses of beverage to be extracted from a single cartridge (obviously a multidose cartridge is proportionally larger).

It should also be considered that since most of the advantages of the present cartridge stem from the elongated cylindrical shape thereof, in some cases one could decide to adopt other manufacturing processes that are different from the process illustrated above as long as the shape is retained. In such an instance there would not be the specific advantages of the use of the sheet material for cylindrical surface S, but advantages of other nature could be achieved.

For example, the cylindrical surface could be obtained by cutting an extruded tube so as to dispense with the sheet rolling and welding steps; or by deep drawing of an aluminum pellet or the like, so as to obtain a cylindrical surface with a base integral therewith and thus eliminate also the welding of said base.

It is therefore clear that the above-described and illustrated embodiment of the cartridge according to the invention is just an example susceptible of various modifications. In particular, bases B, T can be welded both on the inside (preferable in order to have the maximum free surface for the outside print) or both on the outside of cylindrical surface S, or with a reversed arrangement with respect to FIG. 1.

1. Cartridge for the preparation of a beverage, characterized in that it has an elongated cylindrical shape consisting of a lateral cylindrical surface (S) as well as a top base (T) and a bottom base (B) connected to said cylindrical surface (S) so as to close the apertures at the ends of the latter, both the cylindrical surface (S) and said bases (B, T) being made from a gastight material.

2. Cartridge according to claim 1, characterized in that the lateral cylindrical surface (S) is obtained by rolling of a sheet of flexible material and welding thereof along a line (L).

3. Cartridge according to claim 1, characterized in that the lateral cylindrical surface (S) is obtained by cutting an extruded tube.

4. Cartridge according to claim 2 or 3, characterized in that the bases (B, T) are obtained by drawing.

5. Cartridge according to one or more of the preceding claims, characterized in that both bases (B, T) are welded on the inside of the cylindrical surface (S).

6. Cartridge according to one or more of the preceding claims, characterized in that the sheet used for the cylindrical surface (S) is a multi-layer material consisting of PET+aluminum+PET+polythene on the outer surface.

7. Cartridge according to one or more of the preceding claims, characterized in that the sheet used for the bases (B, T) is a multi-layer material consisting of PET+aluminum.

8. Cartridge according to one or more of the preceding claims, characterized in that the welding along the line (L) of the cylindrical surface (S) and/or the welding of the bases (B, T) on the cylindrical surface (S) is carried out through heat sealing.

9. Cartridge according to claim 1, characterized in that the cylindrical surface (S) is obtained by deep drawing of an aluminum pellet or the like, so as to form it with a base already integral therewith.

10. Cartridge according to one or more of the preceding claims, characterized in that its diameter is between 15 and 30 mm, preferably around 24 mm.
